(19) United States
(12) Patent Application Publication
(10) Pub. No.: US 2024/0302390 A1
(43) Pub. Date: Sep. 12, 2024

(54) AUTOMATED DETECTION OF HAZARDOUS ITEMS FOR WASTE MANAGEMENT

(71) Applicant: Whirlwind Intelligent Inspection Systems LLC, Seattle, WA (US)

(72) Inventors: Timothy John WEINERT, Seattle, WA (US); Sahand SABET, Tempe, AZ (US); Sina JAHEDI, Tacoma, WA (US)

(21) Appl. No.: 18/597,886

(22) Filed: Mar. 6, 2024

Related U.S. Application Data
(60) Provisional application No. 63/450,159, filed on Mar. 6, 2023.

(51) Int. Cl. G01N 35/00; G06N 20/00; G06Q 50/26

(52) U.S. Cl. CPC G01N 35/00; G06N 20/00; G06Q 50/26

(57) ABSTRACT

Methods, systems, and apparatus, including computer programs encoded on a computer storage medium, for detecting hazardous materials are disclosed. In one aspect, a method includes the actions of receiving, from one or more sensors, sensor data that reflects characteristics of an environment in a vicinity of the one or more sensors. The actions further include analyzing the sensor data. The actions further include determining that a hazardous material is in the vicinity of the one or more sensors. The actions further include selecting a collection device that is configured to store the hazardous material. The actions further include generating a control instruction that instructs the collection device to collect and store the hazardous material. The actions further include providing, for output to the collection device, the control instruction that instructs the collection device to collect and store the hazardous material.

### CROSS-REFERENCE TO RELATED APPLICATION

This application claims the benefit of US Application 63/450,159, filed Mar. 6, 2023, which is incorporated by reference.

### BACKGROUND

Hazardous materials such as syringes, dangerous chemicals, biological materials, oil, fuels, and the like may pose a serious risk to the public and/or local environment when not disposed of properly. Detecting these hazardous materials may range from manually scanning an open field to, for example using detecting devices that utilize device sensors. In recent times, more technologies are being developed to improve the detection of these hazardous materials.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a diagram of an example network server environment, in accordance with at least one embodiment.

FIG. 2 is a diagram of an example detecting device and waste management operation center (WMOC) server, in accordance with at least one embodiment.

FIG. 3 is a flow diagram of an example procedure, in accordance with at least one embodiment.

FIG. 4 is a flow diagram of another example procedure, in accordance with at least one embodiment.

FIG. 5 is a flow diagram of yet another example procedure, in accordance with at least one embodiment.

### DETAILED DESCRIPTION

This disclosure describes systems and methods for improving identification and location estimation of hazardous materials for proper waste disposal and/or management. Particularly, the identification may be facilitated by a use of one or more machine learning (ML) algorithms to identify a particular type of hazardous material and by extension, a likely geolocation of the identified hazardous material, and estimation of location of additional hazardous materials. Hazardous materials may include, without limitation, syringes, painting wastes, dangerous chemicals, and other type objects that can provide risks to persons or local environment. Although the embodiments herein focused on syringes, these embodiments may similarly apply to other types of hazardous materials. In some implementations, these embodiments may similarly apply to other types of materials that may not be inherently hazardous but may be used in the consumption of controlled substances, such as certain types of aluminum foils used to smoke opioids.

In one embodiment, the identification of the syringes and estimation of their geolocations may be implemented by utilizing syringe identification models and syringe location estimation models, respectively. The syringe identification models may include ML algorithms that can be applied to receive identification features and other data, which are associated with an object, to analyze whether the object is a syringe or another type of hazardous material. The syringe location estimation models may similarly include ML algorithms that can be applied to captured data associated with the object to determine the likely geolocation of additional objects. Here, the detecting device may be configured to search at the estimated locations where the hazardous materials are likely to be found.

In some implementations, the syringe identification models may be derived from historical data of previously identified syringes and their corresponding associated data. The associated data may include, for example, sensor data and environmental data that were used to identify the syringes. In some cases, syringe identification rules that can include pre-defined or user-defined rules may be used to identify the syringes. For example, the syringe identification rules may use a unique combination of numbers given to the radio-frequency identification (RFID) sensor implemented on the syringe to determine whether the object is a syringe or not. Also, the strength of the signal received from the RFID sensor may be used to estimate the distance between the reading device (e.g. drone) to the object being detected (e.g. syringe). In some implementations, an RFID tag on a syringe may include data readable by the detecting device. The RFID data may include the origin of the syringe, the date of manufacture, the contents of the syringe, and/or any other similar data.

In one embodiment, a server, such as a Waste Management Operating Center (WMOC) server, may utilize the syringe identification models on received sensor data to identify whether the received sensor data is associated with a syringe. The sensor data may be captured by a detecting device such as, without limitation, an unmanned aerial vehicle (UAV) or known as drone, a mobile device, a ground vehicle, a camera, light detection and ranging (LIDAR), metal detector or other wand, fluorescent detector, chemical detector, an Internet of Things (IoT) device, or a combination thereof. The received sensor data may include, without limitation, RFID signals, optical tags, captured physical shapes, natural light reflections, heat radiations, chemical odor, or a combination thereof. The detected optical tags may include identified bar codes, QR codes, ultraviolet (UV) rays, fluorescent dyes, and the like. In this embodiment, a portion or all of the received sensor data may be used as inputs to the syringe identification models to generate an output that can include the identification of the object as syringe.

In some cases, and upon receiving of the sensor data, the WMOC server may receive from third-party sources or servers the environmental data that can be associated with a geolocation of the detecting device. The environmental data may include a nature or context that can be associated with the geolocation of the detecting device. For example, the nature may include a community street that can be associated with a low population density, a city street associated with historically high crime rate, hospital area where syringes may be regularly found, a crop field where there is low probability of finding syringes, or other area where chances of finding the syringes may be associated with classification or type of the area.

The context may include presence of a recent activity such as a music concert, day of the week that can be associated with historically increased number of dumped syringes, real-time events that are proximate to the geolocation of the detecting device, and the like. In some embodiments, the context may also include data from third-party server(s), news reports, social media postings, or reports that can describe the disposition of a surrounding environment proximate to the geolocation of the detecting device.

While the sensor data alone may provide a good prediction for the identification of the syringes in ideal detecting conditions such as clear sky, less signal noise interference, etc., the addition of the environmental data can improve a likelihood of the identification and by extension, the estimation of the geolocation of the syringes.

For example, current weather conditions (environmental data) may affect the detection of the wireless signals, capturing of optical tags, or scanning of other identification features such as preconfigured shapes of the hazardous materials. In this example, the current weather conditions, in addition to the captured sensor data, may be used as input data to the syringe identification models to identify the syringe and by extension, the geolocation of the identified hazardous material. In some cases, the syringe location estimation models may be used independently on captured sensor data and environmental data to generate a likely geolocation of the additional syringes. For example, the environmental data includes a recently performed adult concert in a nearby area. In this example, the syringe location estimation models may output a likely location of syringes based on receiving data indicating the concert occurred in the nearby area.

Upon identification of the syringes and the estimation of their corresponding geolocations, one or more ML algorithms may be further employed to infer an ordered ranking of priority for collecting the syringes at their corresponding identified geolocations. In one embodiment, the syringe collection model may be utilized on the identified geolocations of the syringes and the environmental data associated with the identified geolocations to infer the ordered ranking of priority for the collection of these syringes.

For example, the identified geolocations of the syringes to be collected may include a children's playground, dumpsite, and a medical clinic. Here, the environmental data that is associated with each of these identified geolocations may be used as an additional input in the syringe collection model for inferring the ordered ranking of priority for the collection of the syringes. For example, the syringes at the children's playground may be given priority for collection compared to the syringes that are geolocated at the dumpsite. In another example, the syringes at the medical clinic may be given priority for collection compared to the syringes that are geolocated at the dumpsite, and so on.

In some embodiments, the inferred order of ranking for priority of collection of the syringes may be used as a reference to create a dispatch schedule for one or more waste collectors that are assigned to collect these hazardous materials. For example, a waste management service provider employs multiple waste collectors that are randomly scattered in different locations. In this example, a linear algorithm may be used to create the dispatch schedule to maximize availability of the waste collectors, maximize profits for the service provider, or a combination of both.

Further, the term “techniques,” as used herein, may refer to system(s), method(s), computer-readable instruction(s), module(s), algorithms, hardware logic, and/or operation(s) as permitted by the context described above and through the document.

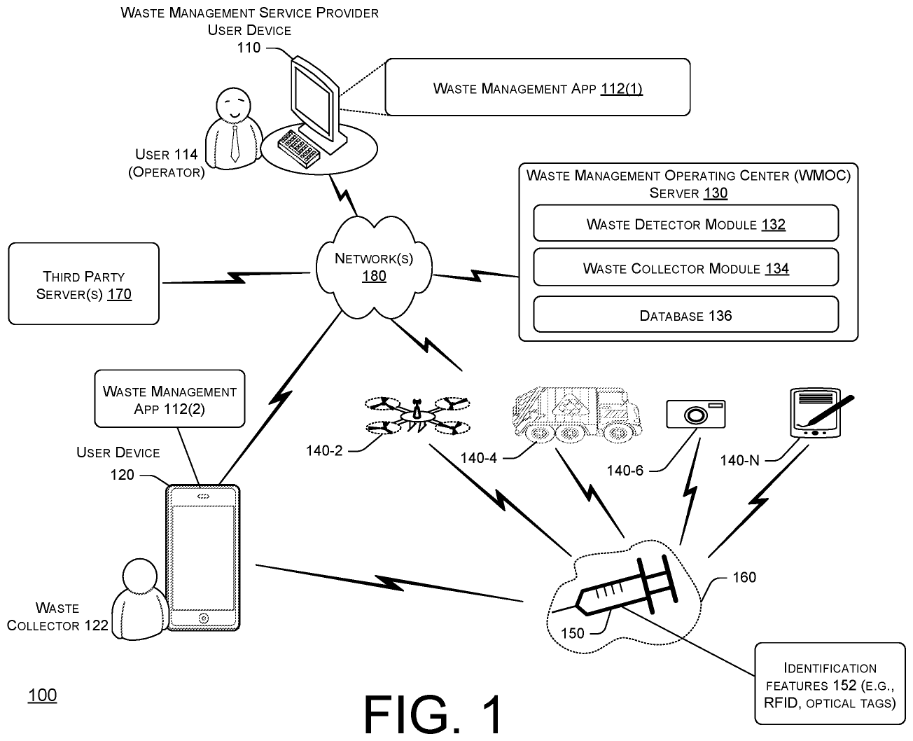

FIG. 1 illustrates a schematic view of a network server environment 100 that facilitates an identification of hazardous materials and estimation of geolocations of additional hazardous materials for collection and proper disposal by waste management personnel. Hazardous items may include, without limitation, syringes, painting wastes, biological wastes, litter, and other type of dangerous goods that can be potential threats to public health or environment. In one embodiment, a waste management operating center (WMOC) server may support subscribers of a waste management application (app) for the identification, estimation of geolocation, and collection of these hazardous materials. The waste management app may be installed in user devices associated with waste management service provider, detecting devices, or user devices associated with service provider personnel. In this embodiment, the waste management app may improve the identification of the hazardous materials, detection of geolocations of additional hazardous materials, and collection of the identified hazardous materials. Although the main embodiment as described herein utilizes the syringes as the type of hazardous materials to be identified, geolocated, and/or collected, the embodiments may similarly apply to the other types of hazardous materials such as paint, lead metals, aerosols, and the like.

As shown, the network environment 100 may include a waste management service provider user device 110 with an installed waste management app 112(1), a user 114 such as a waste management operator or manager, a user device 120 with an installed waste management app 112(2), a waste collector 122 who is associated with the user device 120, a network server such as a WMOC server 130, detecting devices 140-2, 140-4, . . . 140-N(detecting devices 140), a syringe 150 that is located at a geolocation point 160, third party server(s) 170, and one or more networks 180. The WMOC server 130 may further include a waste detector module 132, waste collector module 134, and a database 136. The syringe 150 may further include identification features 152 such as, without limitation, RFID tag, optical tags, syringe shape, or other detectable features that can be captured by the detecting devices 140 and/or user device 120. In some embodiments, the network environment 100 may be or include a cellular network.

The waste management service provider user device 110 or the user device 120 may include an electronic communication device, including but not limited to, a smartphone, a session initiation protocol (SIP) phone, a laptop, a personal digital assistant (PDA), a satellite radio, a global positioning system (GPS), a multimedia device, a video device, a camera, LIDAR, a game console, a tablet, a smart device, a wearable device, or any other similar functioning device. In one embodiment, the service provider user device 110 or the user device 120 may use the waste management app 112(1) or 112(2) to communicate with the WMOC server 130. The waste management app 112(1) or 112(2) (also referred to as waste management app 112) may be used to transmit data to the web server 130 and/or receive data such as the identified geolocations of the syringes and ordered ranking of priority to collect the syringes at the identified geolocations.

The WMOC server 130 may utilize distributed computing resources (e. g., one or more computing devices) that can operate in a cluster or other configuration to share resources, balance load, increase performance, provide fail-over support or redundancy, or for other purposes. The WMOC server 130 may include one or more interfaces to enable communications with the service provider user device 110, user device 120, detecting devices 140, and other networked devices via the one or more network(s) 180. In one embodiment, the WMOC server 130 may receive sensor data that can be captured by the user device 120 and/or the detecting devices 140. The sensor data may include, without limitation, RFID signals, detected UV fluorescent rays, detected shape, or a combination thereof. In this embodiment, the WMOC server 130 may use prediction models to identify the syringe 150 and further to estimate the geolocation 160 of additional syringes. The additional syringes (not shown) may be located in another area, which can be estimated by the use of the syringe location estimation models and/or syringe location estimation rules. As further described in subsequent figures, the prediction models may include syringe identification models and syringe location estimation models.

The WMOC server 130 may also receive environmental data from the third party server(s) 170. The environmental data may include the data that can be associated with the geolocation of the detecting device. In some implementations, the environmental data may include the nature or context that can be associated with a monitored geolocation of the detecting device. The nature may include, without limitation, a community street that can be associated with a low population density, a city street associated with historically high crime rate, hospital area where syringes may be regularly found, a crop field where there is low probability of finding syringes, or other area where chances of finding the syringes may be associated with type or classification of the area.

The context may include presence of a recent activity such as a music concert, day of the week that can be associated with historically increased number of dumped syringes, real-time events that are proximate to the geolocation of the detecting device, and the like. In some embodiments, the context may also include data from third-party server(s), news reports, social media postings, or reports that describe the disposition of a surrounding environment proximate to the geolocation of the detecting device.

With the collected sensor data and environmental data, the WMOC server 130 may use the waste detector module 132 to identify whether an object is a syringe or not. In some embodiments, the waste detector module 132 may use syringe identification models on the collected sensor data and environmental data to identify the syringe 150. Further, the waste detector module 132 may use syringe location estimation models to estimate the geolocation 160 of other, or additional, syringes. In these cases, the prediction models may be trained by historical environmental data and sensor data that are associated with previously identified syringes.

In one implementation, the WMOC server 130 may use the waste collector module 134 to infer an ordered ranking of priority for collecting the identified syringes at their corresponding estimated geolocations. For example, a syringe collection model may be trained from the historical geolocations of the collected syringes and risks associated with the historical geolocations. In some embodiments, an inferred order of ranking for priority of collection of the syringes may be used as a reference by the WMOC server 130 to create a dispatch schedule for one or more waste collectors that are assigned to collect these hazardous materials. For example, a waste management service provider employs multiple waste collectors such as the waste collector 122. In this example, a linear algorithm may be used to create the dispatch schedule to maximize availability of the waste collectors, maximize profits for the service provider, or a combination of both.

The waste management app 112 may include an application that can be installed in a device such as the user device 120 or the service provider user device 110 to access the WMOC server 130. In one embodiment, the user device 120 or the service provider 110 may be required to enter information when subscribing to the waste management app 112. The information may include, without limitation, identification of person associated with the user device 120, identification of the service provider associated with the provider device 110, and other device data. This information may be stored in the database 136 of the WMOC server 130.

The user 114 may include an individual who can be a waste management service provider owner, manager, or operator. In one embodiment, the user 114 may use the service provider user device 110 and particularly, the waste management app 112(1) to access the WMOC server 130. For example, the service provider user device 110 may access and collect the data of the geolocations of the syringes and the created dispatch schedule (not shown). In this example, the service provider user device 110 may communicate with the user device 120 and/or detecting devices 140 to implement the created dispatch schedule.

The waste collector 122 may include an individual who can be an employee of the waste management service provider, or hobbyist who is a subscriber of the waste management app 112 just to collect hazardous materials. In one embodiment, the waste collector 122, via the user device 120, may receive instructions or the dispatch schedule using the installed waste management app 112(2).

The one or more network(s) 180 may include public networks such as the Internet, private networks such as an institutional and/or personal intranet, or some combination of private and public networks. The one or more network(s) 180 can also include any type of wired and/or wireless network, including but not limited to local area network (LANs), wide area networks (WANs), satellite networks, cable networks, Wi-Fi networks, Wi-Max networks, mobile communications networks (e.g., 3G, 4G, and so forth), or any combination thereof.

The detecting devices 140 may include an unmanned aerial vehicle (UAV) or known as drone, a mobile device, metal detector, chemical detector, pressure detector, fluorescent detector, an Internet of Things (IoT) device, or any other types of sensor devices. In one embodiment, the detecting device 140-2 is a drone that hovers above ground and detects the identification features 152 associated with the syringe 150. In another embodiment, the detecting device 140-4 is a garbage truck that uses metal detectors or RFID sensors to detect the identification features 152. In another embodiment, the detecting device 140-6 is a camera, and so on. Without limitation, the identification features 152 may include RFID signals that can be received at different points, optical tags, preconfigured physical shape, preconfigured location of the tags in the body of the syringe, or a combination thereof. Here, while the RFID signals may be used in a triangulation method to detect the geolocation 160 of the syringe 150, the additional and/or alternative use of the other identification features 152 may further improve the detection of the geolocation 160 of the syringe 150.

In another embodiment, an RFID reader can be installed directly on, or placed close to, a sharps container so that the RFID reader can log the syringes dropped into the sharps container. The sharps container can be mounted on a wall in a hospital, clinic, office, etc, or it can be stationed at a fixed location in the streets, or it can be a small handheld sharps container that is given to the cleaning crew patrolling the streets. In some implementations, the sharps container may be included in a device that is configured to collect a syringe in response to receiving an instruction that includes the location of the syringe.

For example, during a rainy weather condition, the use of the RFID signals or other short range communications may be affected by the rain and thus, the optical tags or detected shape may be added to improve the detection of the geolocation 160. In another example, in a covered area where the optical tags are not visible to the detecting devices 140, the RFID signal may be used to identify the geolocation 160. In these examples, the sensor data associated with the collected syringes may be used as historical data to train the prediction model as described herein.

In some embodiments, the detecting devices 140 may include a combination of sensors in the garbage truck 140-4, fluorescent detector in the camera 140-6, and so on. Here, the WMOC server 130 may collect sensor data from these detecting devices 140.

The syringe 150 may include a reciprocating pump with a plunger that fits within cylindrical tube or barrel of the pump. In one embodiment, the cylindrical tube may be associated with a RFID tag, optical tags, preconfigured shape, or a combination thereof. The tags can be added to the cylindrical tube using adhesive, sticker tapes, or such. Also, the tags can be embodied into the plunger or cylindrical tube of the syringe. The same with fluorescent dyes, it can be added to a sticker that wraps around the plunger or cylindrical tube, premixed with the plastic during fabrication of the syringe, or painted on inner or outer body of the syringe after fabrication. In some embodiments, the optical tags or RFID device may be used as a reference for another identification feature of the syringe 150. For example, a detection of the RFID signal may indicate presence of an optical tag that can be used to identify the syringe 150. In another example, a capturing of the optical tag may indicate associated preconfigured shape or size of the syringe. In another example, a detection of a particular RFID signal may indicate absence of additional optical tags to identify the syringe, and so on.

In an example operation, the WMOC server 130 may receive a request from the user device 110 to identify the syringes over a particular area. Here, the WMOC server 130 may receive captured sensor data from the detecting devices 140 and/or the user device 120. The WMOC server 130 may also receive the environmental data from the third party server(s) 170. The WMOC server 130 may then use the prediction models in the waste detector module 132 and/or the waste collector module 134 to identify the syringe 150, estimate the geolocation 160 of syringes other than the syringe 150, or rank the order of priority for the collection of the identified syringes at their corresponding geolocations. The prediction model to identify the syringes and estimate the geolocations of additional syringes are further described in figures below.

In some implementations, the environment 100 may include a web application and/or mobile interface to provide collected data to third parties such as government entities, private entities, schools, etc. The collected data may include the location of the hazardous material, the characteristics of that hazardous material, and/or any other similar information. The collected data may be displayed in graphs, charts, maps, and/or any other similar type of display. The web application and/or mobile interface may be executed by any of the devices illustrated in the environment 100.

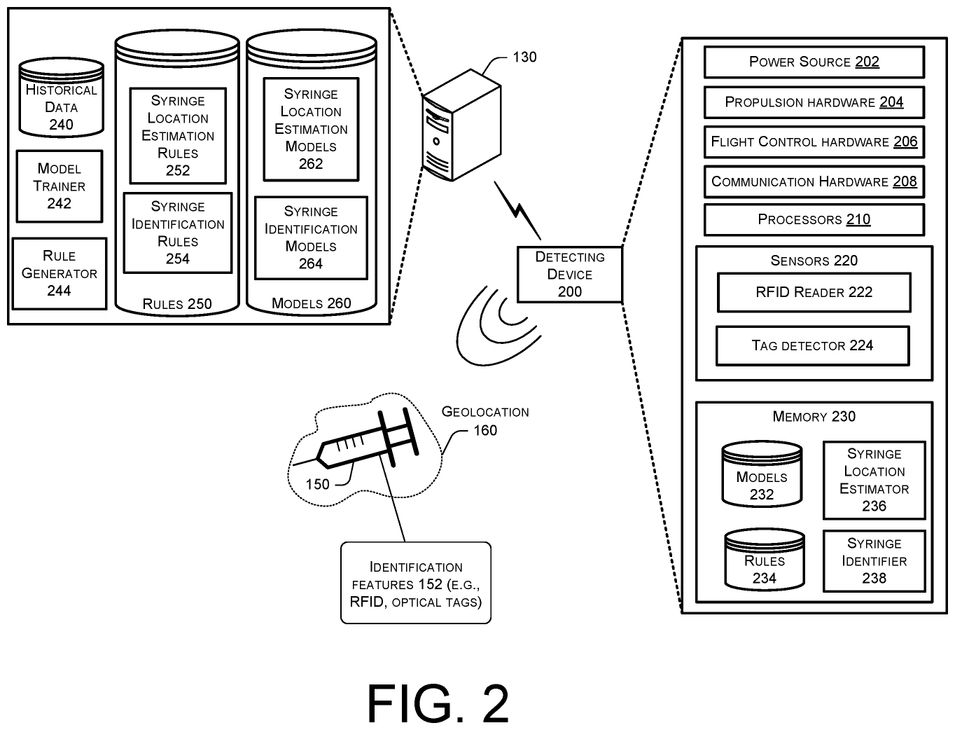

FIG. 2 is a block diagram showing various components of a detecting device 200 that is in communication with the WMOC server 130 to identify syringes and estimate the locations of the other, or additional, syringes. For example, the detecting device 200 may be a drone that can utilize syringe identification models and syringe location estimation models to identify the syringe 150 and estimate the geolocation 160 of additional syringes, respectively.

As shown, the detecting device 200 may include a power source 202, propulsion hardware 204, flight control hardware 206, communication hardware 208, one or more processors 210, sensors 220, and memory 230. The sensors 220 may include, without limitation, an RFID reader 222 and a tag detector 224. The memory 230 may include models 232, rules 234, syringe location estimator 236, and syringe identifier 238. Referencing components of the WMOC server 130, the WMOC server 130 may include historical data 240, model trainer 242, rule generator 246, rules 250, and models 260. The rules 250 may include syringe location estimation rules 252 and syringe identification rules 254. The models 260 may include syringe location estimation models 262 and syringe identification models 264.

The power source 202 may include electrical cells, combustible liquid fuel, combustible gas fuel, compressed gas, and/or other energy sources. In some embodiments, the power source 202 may be a ground-based energy source, rather than an energy source that is carried onboard the detecting device 200. In such embodiments, a power line or fuel line may convey the energy from the ground-based energy source to the detecting device 200. The propulsion hardware 204 may include mechanical devices that can convert the energy provided by the power source 202 into movements of the detecting device 200. For example, the propulsion hardware may include an internal combustion engine, an electrical motor, a jet engine, a turboprop engine, propellers, rotors, and/or so forth that are mounted on the wings and/or the body of the detecting device 200.

The flight control hardware 206 may include actuators and control surfaces that can steer the detecting device 200. For example, the actuators may include hydraulic actuators, gas-powered actuators, electrical actuators, and/or so forth. The actuators may move or deflect control surfaces to control the movement of the detecting device 200. The control surfaces may include tilt wings, rudders, slats, ailerons, elevators, trim tabs, fins, canards, and/or so forth. In some embodiments, the flight control hardware 206 may be integrated with the propulsion hardware 204. For example, such integrated hardware may include tilt rotors, variable pitch rotors, jet engines with movable thrust nozzles, and/or so forth. In some implementations, the flight control hardware 206 may rely on data from the sensors 220, such as LIDAR and images, to navigate, perform mapping functions, and/or perform localization functions. This sensor data may be used by the processors 210 to automatically control the flight control hardware 206 and/or used by an operator.

The communication hardware 208 may include hardware components that enable the detecting device 200 to communicate with other detecting devices, the WMOC server 130, devices associated with the waste collectors, or devices associated with the waste management service provider. In various embodiments, the communication hardware 208 further includes cellular transceivers, hardware decoders and encoders, an antenna controller, a memory buffer, a network interface controller, a universal serial bus (USB) controller, and/or other signal processing and communication components.

Accordingly, the communication hardware 208 may support the transmission and reception data for wireless communication. The communication hardware 208 may further include one or more antennas that support the transmission and reception of data signals. The antennas may include a Yagi antenna, a horn antenna, a dish reflector antenna, a slot antenna, a waveguide antenna, a Vivaldi antenna, a helix antenna, a planar antenna, a dipole array antenna, an origami antenna, and/or other types of antennas. In some instances, an antenna may be oriented to point to a direction via electrical beamforming and/or via mechanical movement of one or more elements of the antenna by an antenna controller.

The sensors 220 may be configured to capture sensor data from objects such as the syringe 150. The RFID reader 222 may detect RFID signals while the tag detector 224 may capture fluorescent tags, bar codes, and the like. Other sensors 220 may include a camera, a LIDAR, image sensor, shape detector, metal detector, optical sensor, chemical sensor, proximity sensor, light sensor, IR sensor, accelerometer, temperature sensor, an altitude sensor, a global positioning system (GPS) sensor, control setting sensors, propulsion setting sensors, and the like. In some implementations, the sensors 220 may coordinate with other devices. The other devices may include a light source, an ultraviolet light source, an infrared light source, and/or any other similar type of device that is configured to provide an output to improve the accuracy of the sensor data. For example, the sensor data may be collected while illuminating the area with visible light and UV light either simultaneously or in sequence. In some implementations, the sensors 220 may include duplicate sensors. For example, two image sensors to improve depth perception. The sensors 220 may provide the sensor data, via the communication hardware 208, to the WMOC server 130 for further processing.

Each of the processors 210 may be a single-core processor, a multi-core processor, a complex instruction set computing (CISC) processor, or another type of processor. The memory 230 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital storage disks or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 210 and the memory 230 may implement models 232, rules 234, syringe location estimator 236, and the syringe identifier 238. The models 232 may include the syringe location estimation models 262 and the syringe identification models 264 that can be associated with the detecting device 200. Due to different types of sensors used and thus, different sensor data that are captured by different detecting devices, each detecting device may be associated with corresponding syringe location estimation models 262 and the syringe identification models 264. For example, the configured syringe identification model for a drone detecting device is different from the configured syringe identification model for a chemical detector. In this example, the sensor data that can be captured by the drone detecting device is different from the sensor data that can be captured by the chemical detector. In this regard, the historical sensor data that can be used to train these detecting devices may be different and separate or work in conjunction with each other. The resulting models may be configured to receive the same type of data used to train them.

In one embodiment, the models 232 may include the syringe identification models 264 that can be used by the syringe identifier 238 to determine whether an object is a syringe or not. In this embodiment, the syringe identifier 238 may use captured sensor data as input, for example, to the syringe identification models 264 to determine whether the captured sensor data corresponds to a detected syringe. In other cases, the syringe location estimation models 264 may be used to estimate the geolocation 160, which can include the likely locations of additional syringes and/or any other objects and features of the environment.

In some implementations, the syringe identifier 238 may be configured to determine a confidence score that indicates a likelihood that the syringe identifier 238 has identified a syringe or the absence of a syringe. For example, the confidence score may be on a range from zero to one, where zero indicates no syringe and one indicates a syringe. A confidence score of 0.5 may indicate an equal chance that the syringe identifier 238 has identified a syringe. In some implementations, if the confidence score is within a range, such as 0.4 to 0.6, then the syringe identifier 238 may capture an image of the area in question and transmit that image and/or video to another computing device for further processing. The further processing may include a user viewing the image and/or video and inputting whether the image includes a syringe.

In some implementations, the syringe identifier 238 may determine the distance and size of syringes and other objects from the detecting device 200. The syringe identifier can translate the distance and size of the syringes and other objects into GPS coordinates using various methods, such as Simultaneous Location and Mapping (SLAM).

In some implementations, the syringe identifier 238 may use the sensor data, for example LIDAR data, to determine a map of the environment where the detecting device 200 is analyzing. The map may be a three-dimensional map, and the syringe identifier 238 may populate the map with likely locations of syringes. The syringe identifier 238 may include a confidence score that the identified locations include a syringe. The map may be used by the detecting device 200 to collect the syringes and/or provided to another computing device for collecting by another device and/or for manual collection.

The models 232 may further include the syringe location estimation models 264 that can be used by the syringe location estimator 236 to determine the geolocation of the additional syringes. In this embodiment, the syringe location estimator 236 may use captured sensor data and the syringe location estimator models 264 to estimate the geolocation of these additional syringes.

Referencing the WMOC server 130, the historical data 240 may include previously identified syringes and their corresponding associated data. The associated data may include, without limitation, the sensor data collected from different detecting devices, environmental data associated with geolocations of the corresponding detecting devices, syringe location estimation rules, syringe identification rules, syringe location estimation models, and syringe identification models.

The model trainer 242 may be configured to analyze the historical data 240. The model trainer 242 may train the models 260 using the historical data 240 and machine learning. The model trainer 242 may generate various data samples based on the historical data 240. Each data sample may indicate the state of the previous sensor data collected from the detecting devices, environmental data received from the third-party servers, and/or any other similar data at a point in time. The resulting models 260 may then be applied to new data samples of sensor data and/or environmental data to identify the syringes and/or estimate the corresponding locations of the identified syringes.

The rule generator 244 may include pre-defined rules or user-defined rules that can be used to independently identify the syringes (syringe identification rules 254) and/or to estimate the location (syringe location estimation rules 252) of syringes. For example, the syringe identification rules may use a unique combination of numbers given to the radio-frequency identification (RFID) sensor implemented on the syringe to determine whether the object is a syringe or not. Also, the strength of the signal received from the RFID sensor may be used to estimate the distance between the reading device (e.g. drone) to the object being detected (e.g. syringe).

In an example operation, the detecting device 200 may receive from the WMOC server 130 a deployment and/or instructions to obtain the sensor data from a particular area or geolocation. In response to a deployment command, the detecting device 200 may manipulate the propulsion hardware 204 and the flight control hardware 206 to fly the detecting device 200 to a predetermined altitude, for example, and hover the detecting device 200 within a predetermined distance from the targeted particular area or geolocation. In response to the instructions to obtain the sensor data, the detecting device 200 may use the propulsion hardware 204, flight control hardware 206, and the sensors 220 to obtain the RFID signals, capture the optical tags, capture shapes, or a combination thereof. The detecting device 200 may then utilize the syringe identifier 238 to identify whether the captured sensor data is associated with the syringe 150. The detecting device 200 may further utilize the syringe location estimator 236 to estimate the geolocation 160 of additional syringes.

In addition to the depicted components of the WMOC server 130, the WMOC server 130 may also include input/output interface(s) such as a display (e.g., a liquid crystal display), speakers, a vibrating mechanism, or a tactile feedback mechanism. The Input/output interface(s) also includes ports for one or more peripheral devices, such as headphones, peripheral speakers, or a peripheral display. Further, the WMOC server 130 may include one or more processor(s) that are operably connected to the memory of the WMOC server 130.

In at least one example, the WMOC server 130 processors may be a central processing unit(s) (CPU), graphics processing unit(s) (GPU), or both a CPU and GPU or any suitable sort of processing unit(s). Each of the one or more processor(s) 308 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution. The processors may also be responsible for executing all computer applications stored in the memory, which can be associated with common types of volatile (RAM) and/or non-volatile (ROM) memory.

In addition to local processors, or alternatively, the detecting device 200 may utilize cloud-based processing and/or memory. In some implementations, syringe identifier 238 and/or syringe location estimator 236 may be implemented using cloud-based processing. In this case, the syringe identifier 238 and/or syringe location estimator 236 may utilize the models 232 and/or rules 234 using cloud-based processing. In some implementations, the detecting device 200 may transmit sensor data to the cloud for further analysis. Processing of the sensor data may occur in the cloud and the detecting device 200 may receive data indicating a likelihood that the detecting device 200 is in the vicinity of a syringe.

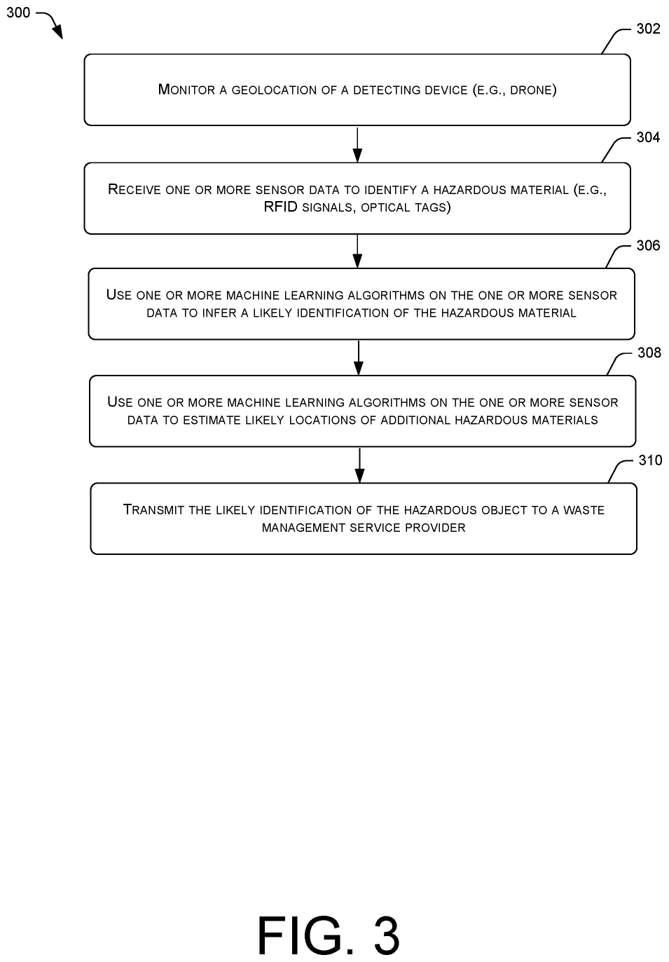

FIGS. 3 through 5 present processes 300, 400, and 500 that relate to operations of the WMOC server 130. Each of the processes 300, 400, and 500 illustrate a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 300, 400, and 500 are described with reference to the network server environment 100 of FIG. 1.

FIG. 3 illustrates a process for employing one or more machine learning algorithms to infer a likely identification of the hazardous material. Process 300 is described from the perspective of the WMOC server 130, which can interact with a detecting device to receive the sensor data as described herein.

At block 302, the WMOC server 130 may monitor a geolocation of a detecting device. The detecting device may include a drone device, camera, LIDAR, user device, and the like. Monitoring may occur continuously, per a predetermined schedule, or in response to a triggering event. Without limitation, the predetermined schedule may correspond to a time interval of one minute, five minutes, 20 minutes, 30 minutes, or one hour. Any time interval is possible. The triggering event may correspond to receipt of a message from the service provider user device to hover over a particular area, for example. In this example, the message may include a request to identify the syringes in the particular area.

At block 304, the WMOC server 130 may receive one or more sensor data from the detecting device. For example, the sensor data may include detected RFID signals at different time instant, bar code, QR code, x-ray fluorescence that emanate from an object, printed chemicals for identifying objects, and the like. In this example, the sensor data are associated with the monitored geolocation of the detecting device.

At block 306, the WMOC server 130 may employ one or more machine-learning algorithms on the received one or more sensor data to infer a likely identification of the hazardous material. For example, the WMOC server 130 may use the syringe identification models 264 on the received one or more sensor data to identify whether one or more objects associated with the sensor data are syringes. In this example, the syringes may include embedded devices that can generate the RFID signals, bar code, QR code, fluorescence that can be captured by camera sensors and LIDAR, different preconfigured shapes, and the like.

In some embodiments, the WMOC server 130 may also receive environmental data that is associated with the detected geolocation of the detecting device. The environmental data from third-party servers may correspond to third-party news reports, social media posting, weather reports, or the like, that describe the disposition of a surrounding environment and real-time events that are occurring proximate to the current or monitored geolocation of the detecting device. Here, the WMOC server 130 may employ the one or more machine-learning algorithms on the one or more sensor data and the environmental data to infer the likely identification of the hazardous material.

At block 308, the WMOC server 130 may employ one or more machine-learning algorithms on the one or more sensor data to estimate likely locations of additional hazardous materials. For example, the WMOC server 130 may use the syringe location estimation models 262 on the one or more sensor data to estimate the geolocations of additional syringes. Here, the next destinations of the detecting device may include the likely locations of additional syringes.

At block 310, the WMOC server 130 may transmit the likely identification of the hazardous material to a waste management service provider. For example, the service provider is associated with the service provider user device 110 of FIG. 1. In this example, the WMOC server 130 may transmit the likely identification of the hazardous material to the service provider user device 110.

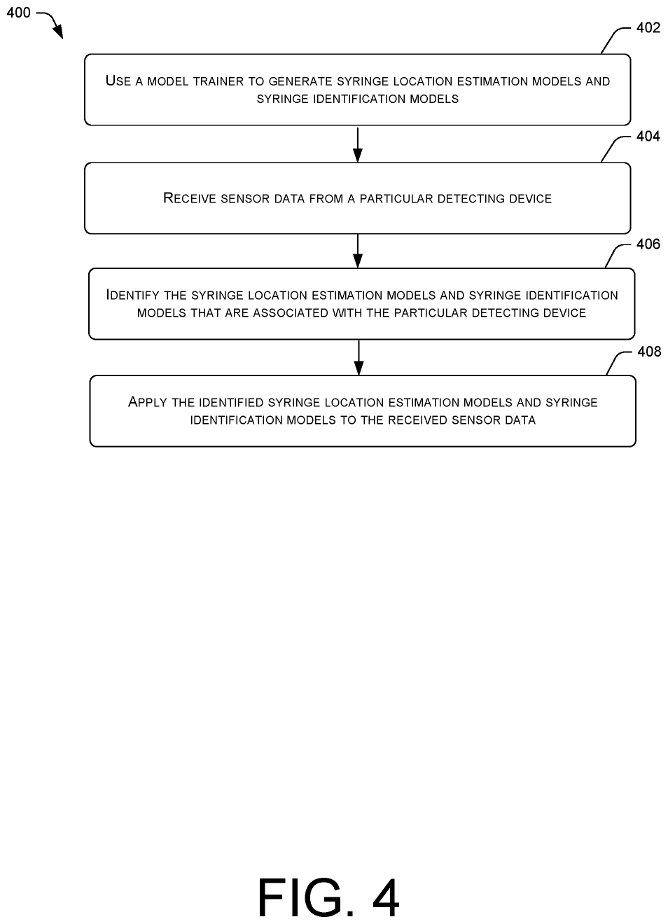

FIG. 4 illustrates a process for generating models to identify a syringe and to estimate a geolocation of additional syringes. Process 400 is described from the perspective of the WMOC server 130.

At block 402, the WMOC server 130 may use a model trainer to generate syringe location estimation models and syringe identification models. In one embodiment, the model trainer may use the historical data 240 to generate the syringe location estimation models 262 and syringe identification models 264 for a particular detecting device. In this embodiment, different detecting devices may include different configured syringe location estimation models 262 and syringe identification models 264.

At block 404, the WMOC server 130 may receive sensor data from a particular detecting device.

At block 406, the WMOC server 130 may identify the syringe location estimation models and syringe identification models correspond to the particular detecting device. In some embodiments, each detecting device may include a particular classification, type, and/or associated sensors. Here, the WMOC server 130 may identify from the database the syringe location estimation models and syringe identification models that are associated with the classification or type of detecting device and/or the type of sensor data collected. For example, the database may include a table of different types of detecting devices and corresponding models.

At block 408, the WMOC server 130 may apply the identified syringe location estimation models and syringe identification models to the received sensor data. For example, the syringe location estimation models 262 and syringe identification models 264 may be used to determine the likely geolocation of additional syringes and identification of the syringe, respectively. In some cases, the identification and location of the syringe may be used in the syringe location estimation models 262 to further estimate the likely locations of additional syringes.

In some implementations, the WMOC server 130 may receive data indicating whether the WMOC server 130 correctly identified a syringe and/or the absence of a syringe. The WMOC server 130 may use this confirmation data and the corresponding sensor data used to determine whether there was likely a syringe and/or the absence of a syringe to update the syringe identification models 264. The WMOC server 130 may add this data to the historical data and retrain the syringe identification models 264 using the updated historical data.

Similarly, the WMOC server 130 may use the data indicating locations of confirmed syringes and/or locations of confirmed absence of syringes to update the syringe location estimation models 262. The WMOC server 130 may update the historical data so that it includes the sensor data used by the WMOC server 130 to determine the likely location of a syringe and whether that location included a syringe. Using the updated historical, the WMOC server 130 may retrain the syringe location estimation models 262.

In some implementations, processes 300, 400, and/or other processes may include an additional feature that includes the system transmits the data related to the location and characteristics of the hazardous material to the web-based application or mobile interface to provide real-time data for third-party customers. This data may include the historical pattern of the substance use associated with the hazardous material as well as predictions for future substance use. This data may be used to determine the answers to questions such as, where/when these syringes or other hazardous material are coming from, where/when have they been used, and where/when they have been disposed of. Using this data and other historical data the system can train special machine learning, deep learning, and/or large language model algorithms to predict when to expect a surge in syringe use and where to allocate appropriate resources.

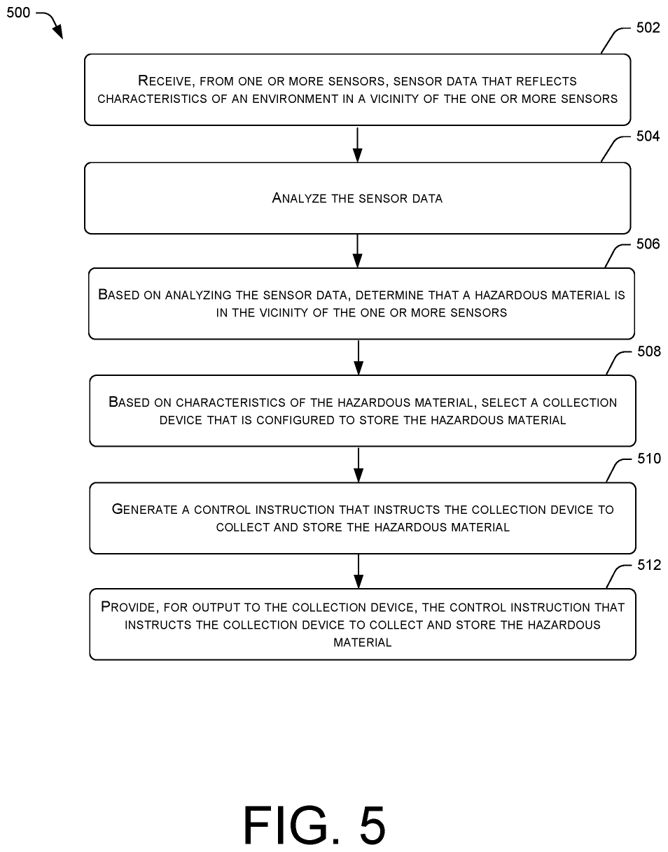

FIG. 5 illustrates a process for utilizing sensor data to determine whether hazardous material is in the vicinity of the sensors generating the sensor data. Process 500 is described from the perspective of the WMOC server 130. In some implementations, the process 500 may be performed by any of the devices illustrated in FIG. 1 or 2. Different devices may perform one or more aspects of the process 500. In some implementations, one or more aspects of the process 500 may be performed by one or more virtual machines.

At block 502, the WMOC server 130 receives, from one or more sensors, sensor data that reflects characteristics of an environment in a vicinity of the one or more sensors. In some implementations, the one or more sensors include a camera, a light detection and ranging device, an RFID detector, a metal detector, a chemical detector, a fluorescence detector, a microphone, a thermometer, a light sensor, a proximity sensor, a pressure sensor, an accelerometer, a gyroscope, a gravity sensor, a magnetometer, a humidity sensor, and/or a barometer. The one or more sensors may be included in a collection device, a detection device, and/or a computing device used by the collector 122.

At block 504, the WMOC server 130 analyzes the sensor data. In some implementations, the server may provide the sensor data as an input to a model that is configured to receive given sensor data and output given data indicating whether given hazardous material is in a given vicinity of given one or more sensors. The model may be trained using machine learning and historical data. The historical data may include sensor data previously collected from the one or more sensors and other sensors. The historical data may also include data identifying whether hazardous material was in the vicinity of the sensors. The historical data may also indicate the type of hazardous material and/or the characteristics of the hazardous material.

In some implementations, different models may be configured to receive different types of sensor data. The type of sensor data that a model is configured to receive may depend on the type of sensor data included in the historical data. With different models configured to receive different types of sensor data, the server may be configured to select a model based on the type of sensor data received from the one or more sensors.

Based on analyzing the sensor data and at block 506, the WMOC server 130 determines that a hazardous material is in the vicinity of the one or more sensors. In some implementations, the server 130 may receive data from the model indicating whether hazardous material is in the vicinity of the one or more sensors. In some implementations, the model may indicate the type of hazardous material and/or a likely location of the material. In some implementations, the hazardous material may be a syringe.

In some implementations, the sensor data may include an RFID code detected from an RFID tag. In some implementations, the sensor data may include another type of code that uniquely identifies the hazardous material. The code may be similar to a serial number other type of code that is unique to a specific item of hazardous material and is used to trace that specific item of hazardous material.

In some implementations, the unique identifier of the hazardous material may be stored in a database or other type of data organization tool. The database may include the unique identifier and other characteristics of the hazardous material. The characteristics of the hazardous material may include a distribution location, a current location, measurements, and/or a type of the hazardous material. For syringes, the characteristic may include the syringe's specifications, such as type, needle gauge, needle length, etc. In some implementations, the characteristics of the hazardous material may be stored in the database at the time the hazardous material is distributed. For example, at the time a syringe is distributed, an RFID reader may scan the RFID tag and the characteristics of the syringe may be stored in the database along with the unique identifier of the RFID tag. In some implementations, at the time a syringe is manufactured, an RFID tag may be applied to the syringe and the characteristics of the syringe may be stored in the database along with the unique identifier of the RFID tag.

In some implementations, the server 130 may analyze the sensor data and/or the characteristics of the hazardous material. Based on this analysis the server 130 may determine a likely location of additional hazardous material. In this case, the server 130 may use models trained using machine learning and historical data that includes previous locations of hazardous material, characteristics of those hazardous material, and/or previous sensor data associated with those hazardous material.

Based on characteristics of the hazardous material and at block 508, the WMOC server 130 selects a collection device that is configured to store the hazardous material. In some implementations, the collection device may be configured to determine the unique identifier of the hazardous material upon storage of the hazardous material. For example, the collection device may include an RFID reader. In some implementations, the collection device is any type of device that is configured to perform an automatic action before, during, and/or after collection of the hazardous material. For example, the collection device may be a scooping device that includes a motor to activate a sweeping component to move the hazardous material into a storage compartment of the collection device. The motor may respond to the control instruction. As another example, the collection device may be container that is placed over the hazardous material. The container may include an automatic door that opens and closes from the power of a motor that responds to the control instruction. A collector may place the collection device over the hazardous material. The motor may receive the control instruction, and the automatic door opens and closes to collect and store the hazardous material.

At block 510, the WMOC server 130 generates a control instruction that instructs the collection device to collect and store the hazardous material. In some implementations, the control instruction may identify a type of storage container to use to store the hazardous material.

At block 512, the WMOC server 130 provides, for output to the collection device, the control instruction that instructs the collection device to collect and store the hazardous material. In some implementations, the collection device may provide data indicating when the collection is complete and data identifying the hazardous material. The server 130 may include the data identifying the hazardous material in the historical data and retrain the model using the updated historical data. In this way, the models used to identify hazardous material may be continuously retrained and updated in order to improve its accuracy and ability to identify hazardous material.

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

What is claimed is:

1. A computer-implemented method, comprising:
receiving, from one or more sensors, sensor data that reflects characteristics of an environment in a vicinity of the one or more sensors;
analyzing the sensor data;
based on analyzing the sensor data, determining that a hazardous material is in the vicinity of the one or more sensors;
based on characteristics of the hazardous material, selecting a collection device that is configured to store the hazardous material;
generating a control instruction that instructs the collection device to collect and store the hazardous material; and
providing, for output to the collection device, the control instruction that instructs the collection device to collect and store the hazardous material.

2. The method of claim 1, wherein:
analyzing the sensor data comprises providing the sensor data as an input to a model that is configured to receive given sensor data and output given data indicating whether given hazardous material is in a given vicinity of given one or more sensors, and
determining that the hazardous material is in the vicinity of the one or more sensors comprises receiving, from the model, data indicating that the hazardous material is in the vicinity of the one or more sensors.

3. The method of claim 2, comprising:
receiving historical data that includes previous sensor data and previous data indicating whether previous hazardous material is in a previous vicinity of previous one or more sensors; and
training, using machine learning and the historical data, the model.

4. The method of claim 3, comprising:
receiving data confirming that the hazardous material is in the vicinity of the one or more sensors; and
updating, using machine learning, the model using the sensor data and the data confirming that the hazardous material is in the vicinity of the one or more sensors.

5. The method of claim 1, comprising:
accessing data that includes the characteristics of the hazardous material and other characteristics of other hazardous materials, wherein the data that includes the characteristics of the hazardous material and the other characteristics of the other hazardous materials is generated during labeling of the hazardous material and the other hazardous materials.

6. The method of claim 1, wherein the hazardous material is a syringe.

7. The method of claim 1, wherein the one or more sensors comprise a camera, a light detection and ranging device, an RFID detector, a metal detector, a chemical detector, a fluorescence detector, a microphone, a thermometer, a light sensor, a proximity sensor, a pressure sensor, an accelerometer, a gyroscope, a gravity sensor, a magnetometer, a humidity sensor, and a barometer.

8. The method of claim 1, wherein the characteristics of the hazardous material includes a distribution location, a location, measurements, and a type of the hazardous material.

9. The method of claim 1, comprising:
based on the characteristics of the hazardous material, determining a likely location of additional hazardous material.

10. The method of claim 1, comprising:
storing data indicating a distribution location of the hazardous material and data indicating the location of the hazardous material.

11. A system, comprising:
one or more processors; and
memory including a plurality of computer-executable components that are executable by the one or more processors to perform a plurality of acts, the plurality of acts comprising:
receiving, from one or more sensors, sensor data that reflects characteristics of an environment in a vicinity of the one or more sensors;
analyzing the sensor data;
based on analyzing the sensor data, determining that a hazardous material is in the vicinity of the one or more sensors;
based on characteristics of the hazardous material, selecting a collection device that is configured to store the hazardous material;
generating a control instruction that instructs the collection device to collect and store the hazardous material; and
providing, for output to the collection device, the control instruction that instructs the collection device to collect and store the hazardous material.

12. The system of claim 11, wherein:
analyzing the sensor data comprises providing the sensor data as an input to a model that is configured to receive given sensor data and output given data indicating whether given hazardous material is in a given vicinity of given one or more sensors, and
determining that the hazardous material is in the vicinity of the one or more sensors comprises receiving, from the model, data indicating that the hazardous material is in the vicinity of the one or more sensors.

13. The system of claim 12, wherein the plurality of acts comprise:
receiving historical data that includes previous sensor data and previous data indicating whether previous hazardous material is in a previous vicinity of previous one or more sensors;
training, using machine learning and the historical data, the model;
receiving data confirming that the hazardous material is in the vicinity of the one or more sensors; and
updating, using machine learning, the model using the sensor data and the data confirming that the hazardous material is in the vicinity of the one or more sensors.

14. The system of claim 11, wherein the plurality of acts comprise:
accessing data that includes the characteristics of the hazardous material and other characteristics of other hazardous materials, wherein the data that includes the characteristics of the hazardous material and the other characteristics of the other hazardous materials is generated during labeling of the hazardous material and the other hazardous materials.

15. The system of claim 11, wherein the hazardous material is a syringe.

16. The system of claim 11, wherein the one or more sensors comprise a camera, a light detection and ranging device, an RFID detector, a metal detector, a chemical detector, a fluorescence detector, a microphone, a thermometer, a light sensor, a proximity sensor, a pressure sensor, an accelerometer, a gyroscope, a gravity sensor, a magnetometer, a humidity sensor, and a barometer.

17. The system of claim 11, wherein the characteristics of the hazardous material includes a distribution location, a location, measurements, and a type of the hazardous material.

18. The system of claim 11, wherein the plurality of acts comprise:
based on the characteristics of the hazardous material, determining a likely location of additional hazardous material.

19. The system of claim 11, wherein the plurality of acts comprise:
storing data indicating a distribution location of the hazardous material and data indicating the location of the hazardous material.

20. One or more non-transitory computer-readable media storing computer-executable instructions that upon execution cause one or more computers to perform acts comprising:
receiving, from one or more sensors, sensor data that reflects characteristics of an environment in a vicinity of the one or more sensors;
analyzing the sensor data;
based on analyzing the sensor data, determining that a hazardous material is in the vicinity of the one or more sensors;
based on characteristics of the hazardous material, selecting a collection device that is configured to store the hazardous material;
generating a control instruction that instructs the collection device to collect and store the hazardous material; and
providing, for output to the collection device, the control instruction that instructs the collection device to collect and store the hazardous material.
